(19) United States
(12) Patent Application Publication
(10) Pub. No.: US 2025/0200500 A1
(43) Pub. Date: Jun. 19, 2025

(54) COMPUTER-IMPLEMENTED METHOD, SYSTEM, COMPUTER PROGRAM, AND COMPUTER-READABLE STORAGE MEDIUM FOR PROVIDING A PRODUCT AT A TARGET LOCATION AT A PREDETERMINABLE TIME

(71) Applicant: Siemens Digital Logistics GmbH, Frankenthal (DE)

(72) Inventors: Johannes Gaerttner, Karlsruhe (DE); Felix Frensch, Pfinztal (DE); Alessandro Guttenberg, Berlin (DE); Tom Stentzel, Karlsruhe (DE)

(21) Appl. No.: 18/981,533

(22) Filed: Dec. 14, 2024

(30) Foreign Application Priority Data
Dec. 14, 2023 (EP) 23216679.3

(51) Int. Cl. G06Q 10/0835; G01C 21/34

(52) U.S. Cl. CPC G06Q 10/08355; G01C 21/3469

(57) ABSTRACT

Provision of a product at a target location at a predeterminable time is provided. A respective resource consumption and a respective transportation duration of a respective transportation route of the product from a predeterminable point of origin to the target location are determined by simulating a plurality of transportation routes from the predeterminable point of origin to the target location. A first transportation route among the plurality of transportation routes that satisfies at least one predeterminable condition with regard to resource consumption and transportation duration is determined. The provision of the product by at least one transportation device according to the first transportation route is initiated.

This application claims the benefit of European Patent Application No. EP 23216679.3, filed on Dec. 14, 2023, which is hereby incorporated by reference in its entirety.

### BACKGROUND

The present embodiments relate to a computer-implemented method for providing a product at a target location at a predeterminable time.

Further, the present embodiments relate to a system having a storage device with data relating to an operating system with a software application, the system further having a computing facility that is configured to execute the software application, where the computing facility is further configured to provide a product at a target location at a predeterminable time.

The present embodiments also relate to a computer program including commands that, when the computer program is executed by the aforementioned system, cause the latter to execute the aforementioned method.

Finally, the present embodiments relate to a computer-readable storage medium including commands that, when executed by the aforementioned system, cause the system to execute the aforementioned method.

Such apparatuses or such a method are used, for example, in a number of transportation tasks in the manufacturing industry. Typically, a number of alternatives are available with regard to the provision or transport of the product, where the alternatives possibly differ (e.g., with regard to the associated effort or the time required for this). For example, the transportation may be internal or external transportation.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved method, a corresponding system, a corresponding computer program, and a corresponding computer-readable storage medium that, for example, facilitate both resource-saving and rapid transportation of a product (e.g., in the case of transportation over long distances or at a future time) are provided.

In one embodiment, a computer-implemented method includes determining a respective resource consumption and a respective transportation duration of a respective transportation route of the product from a predeterminable point of origin to the target location by simulating a plurality of transportation routes from the predeterminable point of origin to the target location; determining a first transportation route among the transportation routes that satisfies at least one predeterminable condition with regard to resource consumption and transportation duration; and initiating the provision of the product by at least one transportation device according to the first transportation route.

In another embodiment, a system includes a computing facility configured to provide a product at a target location at a predeterminable time. The computing facility being configured to provide the product at the target location at the predeterminable time includes the computing facility being configured to: determine a respective resource consumption and a respective transportation duration of a respective transportation route of the product from a predeterminable point of origin to the target location by simulation of a plurality of transportation routes from the predeterminable point of origin to the target location; determine a first transportation route among the transportation routes that satisfies at least one predeterminable condition with regard to resource consumption and transportation duration; and initiate the provision of the product by at least one transportation device according to the first transportation route.

Further, the object is further achieved by a computer program of the type mentioned in the introduction, where the computer program includes commands that, when the program is executed by the system, cause the system to execute the method.

In yet another embodiment, a computer-readable storage medium (e.g., a non-transitory computer-readable storage medium) stores commands (e.g., instructions) that, when executed by the system, cause the system to execute the method. The storage medium may be non-volatile.

The product may be general cargo or bulk cargo. It is possible, for example, for containers containing gases or liquids to be provided to be conveyed accordingly. For example, the product may be configured as a machine or a system or a system part, for example, as a component of a drive train or system automation, such as an electric motor, a gearbox, an inverter, a conveyor facility, etc. The corresponding product is to be provided at a target location (e.g., at a specific location in a factory at which a further processing step is carried out on the product). In other examples, the respective product is consumed at the target location or handed over to the (end) customer. Further, the product is to be provided at the target location at a predetermined time (e.g., on a certain date and at a certain time).

For the provision of the product at the target location at the predetermined time, a number of (e.g., several) transportation routes, by which the product may be transported from a predeterminable point of origin to the target location, are initially considered. For each of the transportation routes, the respective resource consumption and the respective transportation duration for which a simulation is used are determined. Common software applications (e.g., the logistics platform AX4, the Supply Chain Suite (SCS) or XCargo from Siemens Digital Logistics GmbH, Frankenthal, Germany, or similar software applications from other providers) may be used for the simulation (e.g., for event-discrete simulations or also a combination with a continuous simulation). For example, with the support of such software applications, the resource consumption and the transportation duration for the respective transportation route for the product may be determined. The respective resource consumption and the respective transportation duration of at least two different transportation routes (e.g., at least five, at least 20, or up to 100 different transportation routes) are to be determined by the aforementioned simulation. Transportation routes that start at different locations may also be provided if the (same) product is available at different points of origin for transportation to the target location, as will be explained further below.

A first transportation route is determined or selected from the transportation routes under consideration for which the respective resource consumption and the respective transportation duration have been determined. If different transportation routes were determined in the previous act 20, one of the twenty transportation routes is selected as the first transportation route. One of the previously considered transportation routes is selected as the first transportation route if the transportation route to be selected fulfils at least one predeterminable condition with regard to resource consumption and transportation duration. In other words, the resource consumption and the transportation duration associated with the transportation route to be selected meet the aforementioned condition.

For example, the aforementioned condition for the transportation duration may include an acceptable maximum transportation duration (e.g., if the product is perishable or in the case of urgently needed medicines). An acceptable maximum transportation duration for perishable or urgent products may be, for example, 12 or 24 hours. For other products (e.g., heavy and bulky products with no particular urgency), the acceptable maximum transportation duration may also be two to three weeks. In such cases, the acceptable maximum transportation duration may be used, for example, as a boundary condition for the simulation, which provides that the product is transported within a reasonable period. However, since initiation of the provision of the product may in any case take place at the target location at the predetermined time, the acceptable maximum transportation duration in some examples may also be quite long (e.g., a number of weeks or months).

Further, the aforementioned condition for resource consumption may, for example, include an acceptable maximum resource consumption. The maximum resource consumption may include, for example, an amount of fuel or energy or also the duration of use by the respective transportation device, as this is then not available for the transportation of another product. For example, the respective resource consumption may thus be understood as a type of effort that is to be made for the transportation of the product according to the respective transportation route. The respective resource consumption and the respective transportation duration often interact such that a short transportation duration requires high resource consumption and vice versa.

For example, depending on the respective situation, the predeterminable condition may be used to find an optimal first transportation route among the transportation routes available. Depending on the situation and the corresponding predetermined condition, these may also be different transportation routes: for example, when providing urgently needed medicines, the acceptable maximum transportation duration may be comparatively very short, and the acceptable maximum resource consumption may be comparatively very high. This may, for example, be reversed in the transportation of recyclable materials to a recycling system.

If two or more of the transportation routes meet the respective predeterminable condition, the transportation route that best meets the respective condition may be selected as the first transportation route, for example. For example, if two or more of the transportation routes meet the respective predeterminable condition (e.g., equally well), these transportation routes or the determined resource consumption and/or the determined transportation duration of the respective transportation route may, for example, be displayed to the operating personnel by a display device, and, for example, the operating personnel may be enabled to select one of these transportation routes as the first transportation route.

After the first transportation route has been determined, the provision of the product is initiated by at least one transportation device (e.g., a number of transportation devices) according to the first transportation route. The term “initiation” of the provision may be understood, for example, such that the first transportation route is stored, for example, in the storage device, and is made available to the transportation device or is transmitted to the transportation device in order to carry out the corresponding transportation of the product according to the first transportation route. For this purpose, the transportation device, for example, may be informed that the first transportation route is available for retrieval by the transportation device. The system or its computing or storage device may be connected to the transportation device by data technology (e.g., if the determination of the first transportation route of the present embodiments is carried out by the system or its computing facility and the provision of the product is carried out by the transportation device). In some examples, the term “initiation” of the provision may also be that the transportation device directly implements the first transportation route by the system or its computing or storage device transmitting corresponding commands to the transportation device. For example, the initiation of the provision of the product by the at least one transportation device according to the first transportation route may include the provision of the product at the point of origin being initiated by a supplier (e.g., by the system or its computing or storage device being connected to a supplier system by data technology and corresponding request information being transmitted from the system to the supplier system). The transmitted request information may include, for example, information about the product and the time of provision.

The transportation device may include, for example, an automation or programmable logic controller (PLC) and optionally also a drive and an electric motor. In addition, a support structure for supporting or holding the product may be included in the transportation device. The electric motor may be driven by the drive, controlled by the automation controller, and connected to the support structure. Thus, the transportation device is, for example, equipped and configured to transport the product according to the first transportation route. For example, a number of (e.g., several) transportation devices may also be provided. The number of transportation devices are used for the transportation of the product according to the first transportation route. The transportation devices may be used simultaneously and/or sequentially. The sequential use may be provided, for example, for different sections of the first transportation route.

In some examples, the method act of initiating the provision of the product by the at least one transportation device according to the first transportation route is not a necessary part of the computer-implemented method of the present embodiments for providing a product, which applies analogously to the system, the computer program, and the computer-readable storage medium of the present embodiments.

In an embodiment, the predeterminable condition is configured as the optimum of an objective function that takes into account the resource consumption with a first weighting factor and the transportation duration with a second weighting factor.

As already mentioned above, the respective resource consumption and the respective transportation duration may interact such that a short transportation duration requires a high consumption of resources and vice versa. This conflict of objectives may be resolved for many examples by weighting the often mutually unachievable objectives of low resource consumption and short transportation duration. The respective weighting factor represents the value or prioritization of the respective quantity and may also be different depending on the situation or environment. A higher value of the weighting factor expresses a higher value or prioritization.

For the two examples of urgently needed medicines and recyclable materials mentioned above, a weighting may be applied, for example, such that in the case of medicines, the transportation duration would be given ten times greater weight than the resource consumption (e.g., the second weighting factor (for the transportation duration) would be ten, and the first weighting factor (for the resource consumption) would be one). In the case of recyclable materials, the resource consumption may be attributed ten times more weight than the transportation duration (e.g., the first weighting factor (for the resource consumption) would be ten, and the second weighting factor (for the transportation duration) would be one). Assuming that the other parameters (e.g., the respective target location, the respective point of origin, and the respective predeterminable time, as well as other possibly relevant parameters) were the same for the transportation of the medicines and the recyclable materials, different transportation routes may be determined as the respective first transportation route for the medicines and the recyclable materials simply because of the different weighting factors. For example, a particularly fast or efficient transportation device (e.g., a courier or an airplane) may be selected for the transportation of the medicines, or only provided separately for the medicines, consuming more resources, however. For the recyclable materials, however, it may be possible to wait for a transportation device that is only available later, or slower transportation by rail or container ship may be selected, consuming significantly fewer resources.

In a further embodiment, the respective transportation route includes a number of (e.g., several) transshipment points at which the product is transferred from one of the transportation devices to another of the transportation devices.

Transshipment is the loading of transported goods into a means of transport (e.g., loading) or the unloading from a means of transport (e.g., unloading). The product corresponds to the transported goods, and the transportation device corresponds to the means of transport. For example, transshipment may include all conveying and storage operations during the transfer of transported goods to a means of transportation, during the departure of the goods and their change of means of transportation.

For example, each transshipment point is assigned a respective transshipment duration that extends the transportation duration, as the product is not transported during this transshipment duration; the provision of the product at the target location is therefore delayed by the respective transshipment duration. Further, each transshipment point, for example, is assigned a respective transshipment resource consumption, as transshipment consumes resources, such as the energy required for the transshipment or the use of the respective transportation device, which cannot be used elsewhere during the transshipment duration. For example, transshipment may also cause the emission of greenhouse gases (e.g., CO₂), which may also be regarded as a consumption of resources.

In a further embodiment, the respective resource consumption includes at least one form of energy consumption, one form of material consumption, use of the respective transportation device, a greenhouse gas emission, or an expense, each of which is attributable to the transportation of the product.

The respective resource consumption may take into account, for example: the energy consumed for the transportation of the product, which may be measured, for example, in kWh or also in an energy equivalent or a fuel quantity or the like; the material consumed for the transportation of the product (e.g., wear and tear or a fuel quantity); a use of the respective transportation device required for the transportation of the product, which may be taken into account with a certain factor or a certain weighting that takes into account the availability or value or prioritization of the respective transportation device; a greenhouse gas emission caused, for example, by the respective transportation device for the transportation of the product, the greenhouse gases including carbon dioxide (CO₂), methane (CH₄), and nitrous oxide (N₂O) and, for example, it being possible for CO₂ equivalents to be taken into account for the transportation of the product; and an effort made for the transportation of the product, which, for example, includes work required of persons involved in the transportation or a financial expense, which is expressed in costs or a price for the transportation of the product.

For example, the respective resource consumption may depend on the mass and dimensions of the product, for example, as the transportation of heavier and larger products is more complex with regard to the resource consumption required for this. Further, the respective resource consumption may depend, for example, on the transportation device(s) available or used for the transportation of the product. For example, the type of transportation (e.g., by AGV/LWK/ship/airplane), the mode of transport, or the transportation equipment, as well as the utilization of the mode of transport or the respective transportation device are taken into account. The term AGV may be an automated guided vehicle (AGV) (e.g., a floor-mounted conveyor with its own drive) that is automatically controlled and guided without contact. Low utilization of the mode of transport or the respective transport device often leads to higher resource consumption per transported product and vice versa.

In one embodiment, one or more of the aforementioned aspects of resource consumption are taken into account. If a number (e.g., several) of the aforementioned aspects of resource consumption are taken into account, the first weighting factor for resource consumption explained above may be broken down more precisely by defining contributions to the first weighting factor for the various aspects of resource consumption, which represent the value or prioritization of the respective aspect.

In a further embodiment, a plurality of points of origin are available for the production of the product with a respective origin resource consumption, the respective resource consumption of the respective transportation route of the product including the respective origin resource consumption for the production of the product (e.g., at the predeterminable point of origin) and the respective transportation duration of the respective transportation route of the product taking into account the respective point of origin.

In some examples, the product may be available not only at one point of origin, but at a number of (e.g., several) different points of origin, it being assumed that the product is manufactured at the respective point of origin. Further, the production of the product may be assigned a respective origin resource consumption, which expresses how high the resource consumption for the production of the product has been. Even if the product was not or not exclusively manufactured at the respective point of origin but is, for example, only made available at the respective point of origin before it can be transported to the target location, the product may still be assigned a respective origin resource consumption for the respective point of origin, which in each case takes into account the resource consumption from the manufacture of the product until its provision at the respective point of origin.

For example, for a more holistic view, the explained origin resource consumption may also be taken into account in the explained resource consumption for transportation according to the respective transportation routes. For example, the aspects of resource consumption explained above may also be broken down and, if necessary, weighted for the origin resource consumption. For the more holistic view explained above, the respective transportation duration of the respective transportation route may also take into account the respective point of origin, which, for example, may result in transportation routes of different lengths and thus also transportation durations of different lengths.

Such a more holistic view may, for example, lead to a change in the supplier who provides the product for transportation from the respective point of origin to the target location. This may be the case, for example, if a supplier at a point of origin with a favorable transportation route for the product has high origin resource consumption, but another supplier at a different point of origin with a rather unfavorable transportation route has very low origin resource consumption for the product. However, the rather unfavorable transportation route of the other supplier may still have to be covered in an acceptable transportation duration, at least in the overall assessment.

In a further embodiment, the predeterminable time is a number of (e.g., several) years in the future, scaling into the future being made for the respective resource consumption based on at least one macroeconomic parameter and the respective macroeconomic parameter taking into account an increase in productivity, progress in terms of productivity, an inflation rate, a gross domestic product, or purchasing power parity (e.g., along the respective transportation route of the product).

For example, for longer-term security of supply with regard to the product, the (e.g., simulated) predeterminable time may be a number of (e.g., several) years in the future. For a realistic determination of the first transportation route in the future, the respective, future resource consumption of the various transportation routes may at least be estimated. Scaling into the future is undertaken for the respective resource consumption based on at least one macroeconomic parameter. It is possible, for example, for the current (or most recently available) respective resource consumption to form the basis of the scaling.

In one embodiment, the scaling is undertaken based on a respective macroeconomic parameter that is also known or may at least be estimated for times further in the future and for different countries or geographic regions. For example, forecasts for future values of the respective macroeconomic parameter may therefore also be used.

Productivity growth, for example, may be used as a parameter that describes an increase in output per input unit (e.g., a positive change over time in the ratio of production result to the production factors used, such as labor, capital, and environment). Productivity gains may result, for example, from more efficient work processes, improved organizational structures, improved framework conditions of the state, technological progress in general, and increased use of the production factors labor and capital. Of particular relevance to productivity growth in connection with the transportation of the product is technological progress. As a result of this, resource consumption for the transportation of the product tends to be reduced over time. Further, productivity growth may be used for scaling (e.g., an increase in labor productivity). Other scaling parameters may be, for example, an inflation rate (also known as the rate of price increase or inflation; refers to the increase in the general price level), a gross domestic product (e.g., the total value of all goods and services that were generated as end products within the national borders of an economy during a financial year, after deducting all advance payments), or purchasing power parity. Purchasing power parity exists between two geographical areas in the same currency area if goods and services in a basket of goods may be purchased for the same amount of money. If two different currency areas are compared, the amounts of money are made comparable using exchange rates.

In one embodiment, two or more of the parameters mentioned may be used for scaling and, if necessary, weighted. Further, in the case of transportation routes through several countries or geographical regions, the respective, aforementioned parameters may be locally determined and then added up over the entire, respective transportation route (e.g., suitably weighted according to route length) in order to be able to adequately take into account local contributions to the scaling of the respective resource consumption.

The consideration of longer-term security of supply as explained above may also be used, for example, to identify a need for long-term or strategic changes and to initiate corresponding measures, such as the aforementioned change of supplier or the establishment of a new supplier.

The advantage of using the respective macroeconomic parameter is, for example, that comparatively reliable conclusions and results with regard to future respective resource consumption are made possible, although detailed knowledge about individual aspects of the respective resource consumption of the respective transportation route is often not available for the future. Although the respective macroeconomic parameter may seem crude, nevertheless, it is possible to make a good assessment of the aforementioned scaling, which, at the same time, is easy to perform.

In a further embodiment, the computer-implemented method also includes the method act of providing information about the respective resource consumption with regard to internal or external transportation or transportation by land, road, rail, ship, or air, or to transshipment or storage processes (e.g., via at least one programming interface to a respective information database or to a respective web server that has the respective information at its disposal).

The various aspects of the respective resource consumption are often available in special information databases or via web servers and may thus be retrieved by the proposed system to determine the respective resource consumption and, if applicable, the respective transportation duration.

The information for internal transportation may also be available internally, for example, in an MES, SCADA, or ERP system that, for example, is connected to the system of the present embodiments by data technology. MES (manufacturing execution system) is a process-oriented operating level of a multi-layered production management system; supervisory control and data acquisition (SCADA), in the context of industrial control systems, is a computer system or software for monitoring and controlling technical processes; and ERP (enterprise resource planning) is the entrepreneurial task of planning, controlling, and managing personnel, resources, capital, equipment, materials, and information and communication technology in a timely and needs-based manner in line with the purpose of the company.

The information about external transportation is available, for example, via external information databases or web servers (e.g., the system of the present embodiments may refer to the Baltic Dry Index (BDI) for transportation routes by air and water, which is published by the Baltic Exchange in London and is an important price index for the global shipping of dry bulk commodities (mainly coal, iron ore and grain) on standard routes and an indicator of the state of the world economy).

For transportation routes on land, the system of the present embodiments may (e.g., for road transportation) refer to diesel prices or electricity prices, labor costs, and depreciation costs, and to common route planners that are also available in special information databases or via web servers. Corresponding information is available for rail transport, for example, using a scaling factor based on the information regarding road transport.

The system of the present embodiments may have a programming interface for data exchange with the respective information source. A programming interface is also referred to as an application interface (e.g., an interface for programming applications, application programming interface (API)) and is a program part that is made available by a software system to other programs for connection to the system. For example, the system of the present embodiments may receive the information about the respective resource consumption via an API from a corresponding information database or a web server. A web server (Latin servire ‘to serve’; English server ‘servant’, ‘service’) is a server that transmits documents to clients such as, for example, web browsers. The term web server refers to a computer with web server software or just the web server software itself. Web servers may be used locally, in company networks, and predominantly as a WWW service on the Internet. Documents, such as the information mentioned here, may thus be made available for the required purpose locally, in-house, and worldwide.

In a further embodiment, the computer-implemented method also includes the method acts or the method acts: Displaying the determined resource consumption and/or the determined transportation duration of the first transportation route of the product and optionally the respective point of origin on a display device and/or storage of the determined resource consumption and/or the determined transportation duration of the first transportation route of the product together with the product and optionally the respective point of origin in a product lifecycle management (PLM) database.

The display of the determined resource consumption and/or the determined transportation duration of the first transportation route of the product and optionally the respective point of origin on a display device may make it easier for the operating personnel, for example, to plan and carry out the transportation of the product. For example, the corresponding information regarding the second-best or other transportation routes may also be displayed, and the operating personnel may be offered two or more of the transportation routes for selection (e.g., with the aid of the display device). As already explained above, a number of (e.g., several) transportation routes or the determined resource consumption and/or the determined transportation duration of the respective transportation route may be displayed to the operating personnel by a display device, and, for example, it may be made possible for the operating personnel to select one of these transportation routes as the first transportation route. The selection of one of the transportation routes by the operating personnel may be made, for example, using an input device, such as a keyboard, a computer mouse, or a microphone for voice input.

In addition or alternatively, the determined resource consumption and/or the determined transportation duration of the first transportation route of the product together with information about the product and optionally the respective point of origin may be stored in a PLM database and, for example, linked to other product life cycle information of the product. PLM may be a concept for the seamless integration of all information that is generated in the course of the life cycle of a product (e.g., from product development to production release). For example, this information may be further linked to corresponding information regarding the product in connected MES, SCADA, or ERP systems, which enables complete traceability of the product from brainstorming to provision to the customer and, if necessary, beyond. In one embodiment, the transfer of information from the system of the present embodiments to the PLM or MES, SCADA, or ERP system takes place using an API or a web server. The information is available in a JSON file, and it is possible for the information to be transmitted. JSON (JavaScript Object Notation) is a compact data format in an easy-to-read text form for data exchange between applications. JSON is independent of programming languages. Parsers and generators exist in all common languages.

In a further embodiment, the computer-implemented method further includes the method act: Provision of the product by the at least one transportation device according to the first transportation route.

In one embodiment, the transportation device directly implements the first transportation route, for example, by the system or its computing or storage device transmitting corresponding commands to the transportation device and the transportation device executing the received commands for transportation of the product. Further, for example, the provision of the product at the point of origin may be initiated by a supplier, for example, by the system or its computing or storage device being connected by data technology to a supplier system and corresponding request information being transmitted from the system to the supplier system. In some examples, the respective transportation device is included in the system of the present embodiments.

In one embodiment, the computer-implemented method of the present embodiments, the corresponding system, the corresponding computer program, and the corresponding computer-readable storage medium are used to provide more than one product. The multiple products may be of the same or different types. For example, the first transportation route may be determined, and the corresponding transportation according to the determined first transportation route may be carried out simultaneously for a number of (e.g., several) products (e.g., if the aforementioned products have the same point of origin, the same target location, or at least in sections the same first transportation route). In such constellations, particularly resource-saving and fast transportation of the products may be made possible. For this purpose, the explained method acts may be carried out for each of the products to be transported, and then, an optimization of the transportation of the products may be carried out, for example, also by respective, further weighting factors for the respective product.

### BRIEF DESCRIPTION OF THE DRAWINGS

FIGS. 1-4 show diagrammatic view of first to fourth example embodiments of a system, respectively; and

FIG. 5 shows a diagrammatic view of a flow chart of an example embodiment of a method.

### DETAILED DESCRIPTION

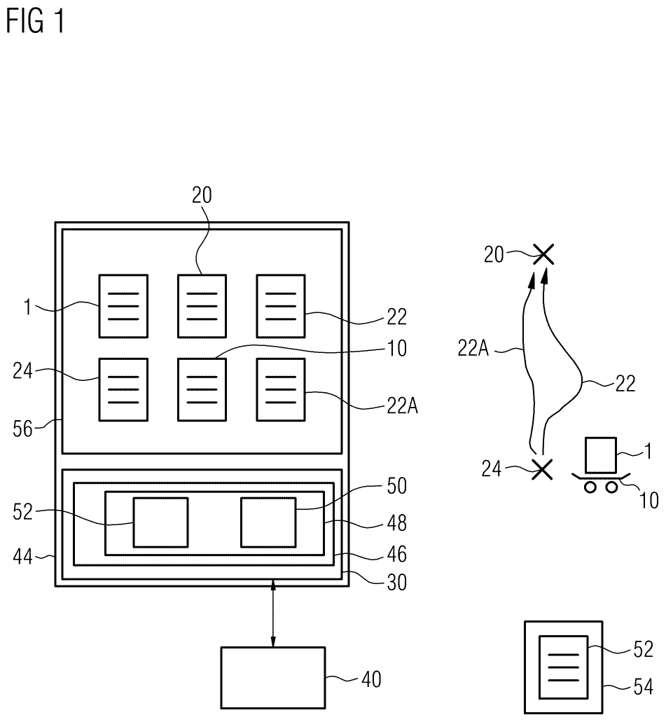

FIG. 1 shows a diagrammatic view of a first example embodiment of a proposed system 44.

The system 44 has a storage device 46 with an operating system 48 and data 52 relating to a software application 50 that is also included in the operating system 48. Further, the system 44 has a computing facility 30 that is configured to execute the software application 50. Further, the computing facility 30 is configured to perform the following acts for providing a product 1 at a target location 20 at a predeterminable time: Determining a respective resource consumption and a respective transportation duration of a respective transportation route 22 of the product 1 from a predeterminable point of origin 24 to the target location 20 by simulating a plurality of transportation routes 22 from the predeterminable point of origin 24 to the target location 20; determining a first transportation route 22A among the plurality of transportation routes 22 that satisfies at least one predeterminable condition with regard to the resource consumption and the transportation duration; and initiating the provision of the product 1 by at least one transportation device 10 according to the first transportation route 22A.

To carry out the acts explained, the system 44 has a further memory 56 in which information about the product 1, the transportation device 10, the target location 20, and the point of origin 24 is available or stored. The determined first transportation route 22A is also stored in the further memory 56. Further, the system 44 optionally has a display device 40 on which, for example, the determined resource consumption and/or the determined transportation duration of the first transportation route 22A of the product 1 and, further, optionally, the respective point of origin 24 may be displayed to the operating personnel.

In some examples, the method act initiating the provision of the product 1 by the at least one transportation device 10 according to the first transportation route 22A is not a necessary part of the provided, computer-implemented method for providing a product 1, which applies analogously to the provided system 44, computer program 52, and computer-readable storage medium 54.

FIG. 1 also shows a computer-readable storage medium 54 (e.g., a non-transitory computer-readable storage medium) and a computer program 52. In this case, the computer program 52 is stored on the computer-readable storage medium 54. The computer program 52 includes commands that, when the computer program 52 is executed by the system 44, cause the system 44 to execute the provided method.

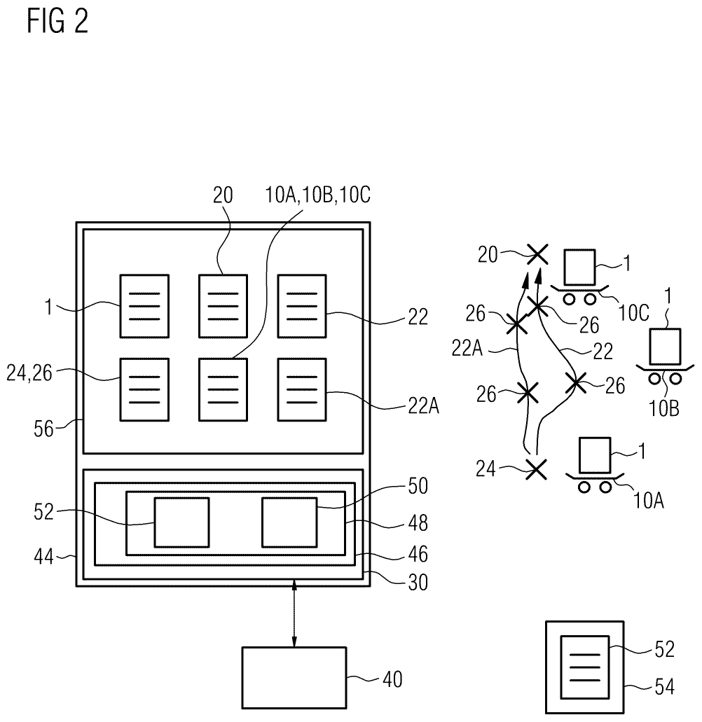

FIG. 2 shows a diagrammatic view of a second example embodiment of the provided system 44, the same reference characters as in FIG. 1 referring to the same objects.

In a modification of the first example embodiment, in the second example embodiment, two transshipment points 26 are provided for each of the two transportation routes 22. At the first transshipment point 26, the product 1 is transferred from a first transportation device 10A to a second transportation device 10B, and at the second transshipment point 26, the product 1 is transferred from the second transportation device 10B to a third transportation device 10C.

Information about the transshipment points 26 and the transportation devices 10A, 10B, 10C is also stored in the additional memory 56.

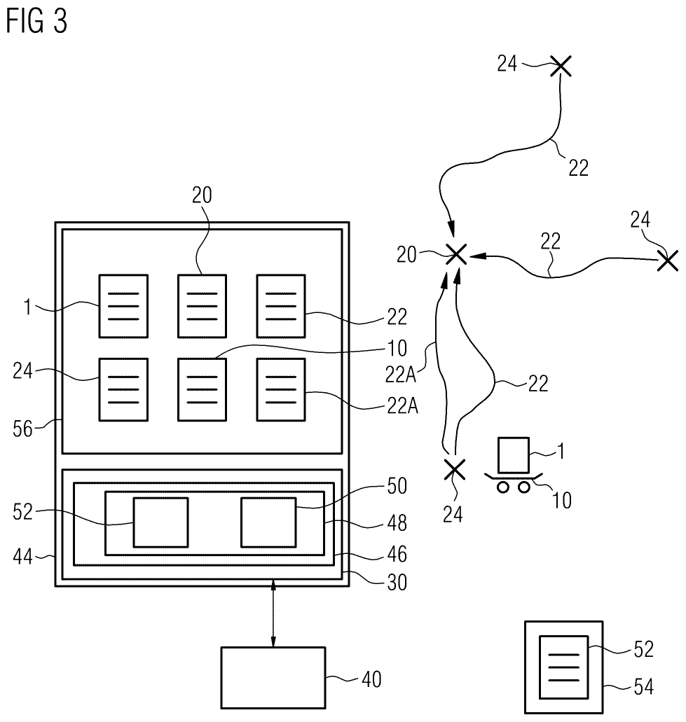

FIG. 3 shows a diagrammatic view of a third example embodiment of the provided system 44.

In a modification of the first or second example embodiment, in the third example embodiment, a plurality of points of origin 24 are available for the production or provision of the product 1. In this case, a respective origin resource consumption is assigned to each of the points of origin 24 with regard to the product 1. The respective origin resource consumption is included and taken into account in the determination of the respective resource consumption with regard to the respective transportation route 22 of the product 1 from the respective point of origin 24 to the target location 20. Further, the respective point of origin 24 is also taken into account for the respective transportation duration of the respective transportation route 22 of the product 1.

Information about the points of origin 24 and, if applicable, the respective origin resource consumption is also stored in the further memory 56.

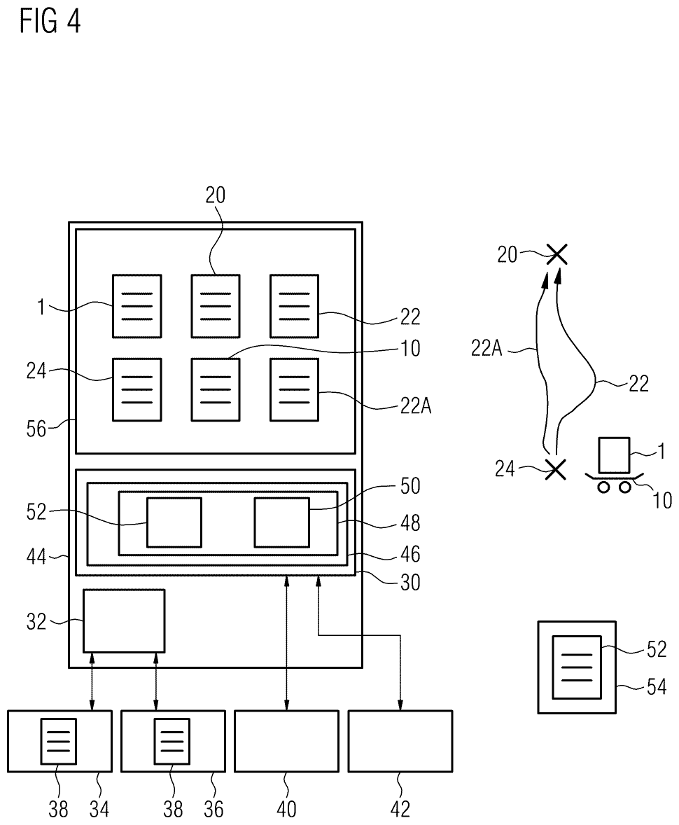

FIG. 4 shows a diagrammatic view of a fourth example embodiment of the provided system 44.

In the fourth example embodiment, the system 44 also has a programming interface 32 with which the system 44 is connected to an information database 34 and to a web server 36 by data technology. The information database 34 and the web server 36 may provide the system 44 with information 38 (e.g., about the respective resource consumption with regard to internal or external transportation or transportation by land, road, rail, ship or air, or to transshipment or storage processes).

Further, the system 44 is connected by data technology to a PLM database 42, in which the determined resource consumption and/or the determined transportation duration of the first transportation route 22A of the product 1 may be stored together with information about the product 1 and optionally the respective point of origin 24.

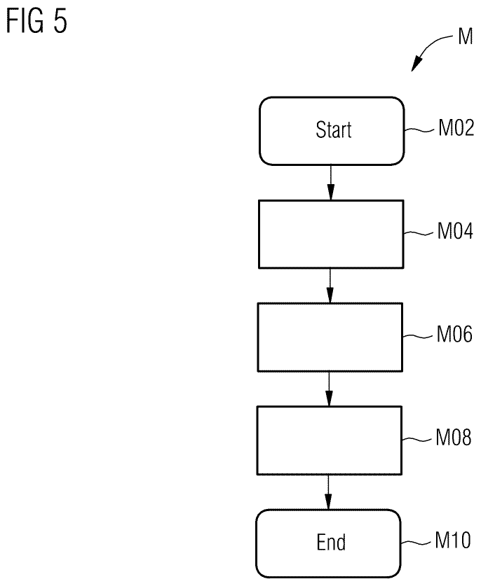

FIG. 5 shows a diagrammatic view of a flow chart of an example embodiment of the provided method. For example, for one of the systems shown in FIGS. 1 to 4, the sequence M may start with the act M02 and include a plurality of acts that may be executed by a processor (e.g., the computing facility explained above).

These acts include: the act M04, according to which the respective resource consumption and the respective transportation duration of a respective transportation route of the product from a predeterminable point of origin to the target location are determined by simulating a plurality of transportation routes from the predeterminable point of origin to the target location; the act M06, according to which a first transportation route among the transportation routes is determined, which satisfies at least one predeterminable condition with regard to the resource consumption and the transportation duration; and the act M08, according to which the provision of the product by at least one transportation device corresponding to the first transportation route is initiated. The process may end with the act M10.

In some examples, the explained process M may include further acts that were explained above in connection with the provided method or the provided system.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for providing a product at a target location at a predeterminable time, the computer-implemented method comprising:
determining a respective resource consumption and a respective transportation duration of a respective transportation route of the product from a predeterminable point of origin to the target location, the determining of the respective resource consumption and the respective transportation duration comprising simulating a plurality of transportation routes from the predeterminable point of origin to the target location;
determining a first transportation route among the plurality of transportation routes that satisfies at least one predeterminable condition with regard to the respective resource consumption and the respective transportation duration; and
initiating the providing of the product by at least one transportation device according to the first transportation route.

2. The computer-implemented method of claim 1, wherein the at least one predeterminable condition is configured as an optimum of an objective function that takes into account the respective resource consumption with a first weighting factor and the respective transportation duration with a second weighting factor.

3. The computer-implemented method of claim 1, wherein the respective transportation route comprises a plurality of transshipment points at which the product is transferred from one transportation device of the at least one transportation devices to another transportation device of the at least one transportation device.

4. The computer-implemented method of claim 1, wherein the respective resource consumption comprises at least one form of energy consumption, one form of material consumption, use of the respective transportation device, a greenhouse gas emission, or an expense, each of which is attributable to the transportation of the product.

5. The computer-implemented method of claim 1, wherein a plurality of points of origin are available for production of the product with a respective origin resource consumption,
wherein the respective resource consumption of the respective transportation route of the product comprises the respective origin resource consumption for the production of the product, and
wherein the respective transportation duration of the respective transportation route of the product takes into account the predeterminable point of origin.

6. The computer-implemented method of claim 5, wherein the respective resource consumption of the respective transportation route of the product comprises the respective origin resource consumption for the production of the product at the predeterminable point of origin.

7. The computer-implemented method of claim 1, wherein the predeterminable time is a number of years in the future,
wherein a scaling into the future is carried out for the respective resource consumption based on at least one macroeconomic parameter, and
wherein the respective macroeconomic parameter takes into account an increase in productivity, progress in terms of productivity, an inflation rate, a gross domestic product, or purchasing power parity.

8. The computer-implemented method of claim 7, wherein the respective macroeconomic parameter takes into account the increase in productivity, the progress in terms of productivity, the inflation rate, the gross domestic product, or the purchasing power parity along the respective transportation route of the product.

9. The computer-implemented method of claim 1, further comprising:
providing information about the respective resource consumption with regard to internal or external transportation or transportation by land, road, rail, ship or air, or about transshipment or storage processes.

10. The computer-implemented method of claim 9, wherein providing the information comprises providing the information via at least one programming interface to a respective information database or to a respective web server that has the information in each case.

11. The computer-implemented method of claim 1, further comprising:
displaying the determined respective resource consumption, the determined respective transportation duration, or the determined respective resource consumption and the determined respective transportation duration of the first transportation route of the product on a display device;
storing the determined respective resource consumption, the determined respective transportation duration, or the determined respective resource consumption and the determined respective transportation duration of the first transportation route of the product together with information about the product in a product life cycle management database; or
a combination thereof.

12. The computer-implemented method of claim 1, further comprising:
displaying the respective point of origin on the display device;
storing the respective point of origin in the product life cycle management database; or
a combination thereof.

13. The computer-implemented method of claim 1, further comprising:
providing the product by the at least one transportation device according to the first transportation route.

14. A system comprising:
a storage device comprising an operating system with data relating to a software application; and
a computing facility configured to:
execute the software application;
provide a product at a target location at a predeterminable time, the computing facility being configured to provide the product at the target location at the predeterminable time comprising the computing facility being configured to:
determine a respective resource consumption and a respective transportation duration of a respective transportation route of the product from a predeterminable point of origin to the target location, the computing facility being configured to determine the respective resource consumption and the respective transportation duration comprising the computing facility being configured to simulate a plurality of transportation routes from the predeterminable point of origin to the target location;
determine a first transportation route among the plurality of transportation routes that satisfies at least one predeterminable condition with regard to the respective resource consumption and the respective transportation duration; and
initiate the provision of the product by at least one transportation device according to the first transportation route.

15. A non-transitory computer-readable storage medium that stores instructions executable by one or more processors to provide a product at a target location at a predeterminable time, the instructions comprising:
determining a respective resource consumption and a respective transportation duration of a respective transportation route of the product from a predeterminable point of origin to the target location, the determining of the respective resource consumption and the respective transportation duration comprising simulating a plurality of transportation routes from the predeterminable point of origin to the target location;
determining a first transportation route among the plurality of transportation routes that satisfies at least one predeterminable condition with regard to the respective resource consumption and the respective transportation duration; and
initiating the providing of the product by at least one transportation device according to the first transportation route.

16. The non-transitory computer-readable storage medium of claim 15, wherein the at least one predeterminable condition is configured as an optimum of an objective function that takes into account the respective resource consumption with a first weighting factor and the respective transportation duration with a second weighting factor.

17. The non-transitory computer-readable storage medium of claim 15, wherein the respective transportation route comprises a plurality of transshipment points at which the product is transferred from one transportation device of the at least one transportation devices to another transportation device of the at least one transportation device.

18. The non-transitory computer-readable storage medium of claim 15, wherein the respective resource consumption comprises at least one form of energy consumption, one form of material consumption, use of the respective transportation device, a greenhouse gas emission, or an expense, each of which is attributable to the transportation of the product.
